(19) United States
(12) Patent Application Publication
(10) Pub. No.: US 2004/0248525 A1
(43) Pub. Date: Dec. 9, 2004

(54) Radar duplexing arrangement

(75) Inventor: Brian Prime, Lincoln (GB)

Correspondence Address: VENABLE, BAETJER, HOWARD AND CIVILETTI, LLP, P.O. BOX 34385, WASHINGTON, DC, 20043-9998, US

(73) Assignee: E2V Technologies Limited, Chelmsford (GB)

(21) Appl. No.: 10/849,541

(22) Filed: May 20, 2004

(30) Foreign Application Priority Data
May 20, 2003 (GB) 0311580.5

(51) Int. Cl. H04B 1/02

(52) U.S. Cl. 455/101

(57) ABSTRACT

A car radar duplexing arrangement for permitting a ingle antenna to transmit and receive electromagnetic radiation, comprising a circular waveguide, a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide, a polariser disposed within the waveguide for conversion of linear waves into circular waves and vice-versa, and an antenna feed in communication with the polariser to transmit and receive circular waves.

### CROSS-REFERENCE TO RELATED APPLICATION

This application claims the priority of British Application No. 0311580.5 filed on May 20, 2003, the subject matter of which is incorporated herein by reference.

### BACKGROUND OF THE INVENTION

The present invention is concerned with a radar duplexing arrangement. Radar (Radar is an acronym for Radio Detection and Ranging) operates by radiating or transmitting electromagnetic energy or waves (not necessarily radio waves as name implies) and detecting the echo returned from reflecting objects. The nature of the detected signal or echo and its relationship to the transmitted signal provides information about the target from which the waves have been reflected.

Radar arrangements therefore require both the transmission and reception of electromagnetic signals or waves. Duplexing arrangements allow one to use a single antenna to both transmit and receive at the same time. A duplexer is a system or arrangement which controls the routing of signals. A radar duplexer will therefore distinguish between signals for transmission and those signals that have been received and route them appropriately. Known duplexer arrangements include ferrite circulator duplexers. These are bulky, complicated and/or expensive devices.

### SUMMARY OF THE INVENTION

The present invention provides a radar duplexing arrangement for permitting a single antenna to transmit and receive electromagnetic radiation, comprising: a circular waveguide; a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide; a polariser disposed within the waveguide for conversion of linear waves into circular waves and vice-versa; and an antenna feed in communication with the polariser to transmit and receive circular waves. Additional features of the invention will become apparent from the following detailed description taken in conjunction with the accompanying drawings.

### BRIEF DESCRIPTION OF THE DRAWINGS

A preferred embodiment of the invention will now be described, by way of example, with reference to the attached figures (which are not to scale) in which:

FIG. 1 is a block diagram illustrating the basic elements of a radar arrangement using a single antenna for transmission and reception;

FIG. 2 is an illustration (an exploded view) of the duplexer of FIG. 1;

FIG. 3 is a side view through the duplexer of FIGS. 1 and 2; and

FIG. 4 is a cross-sectional view along line A-A of FIG. 3.

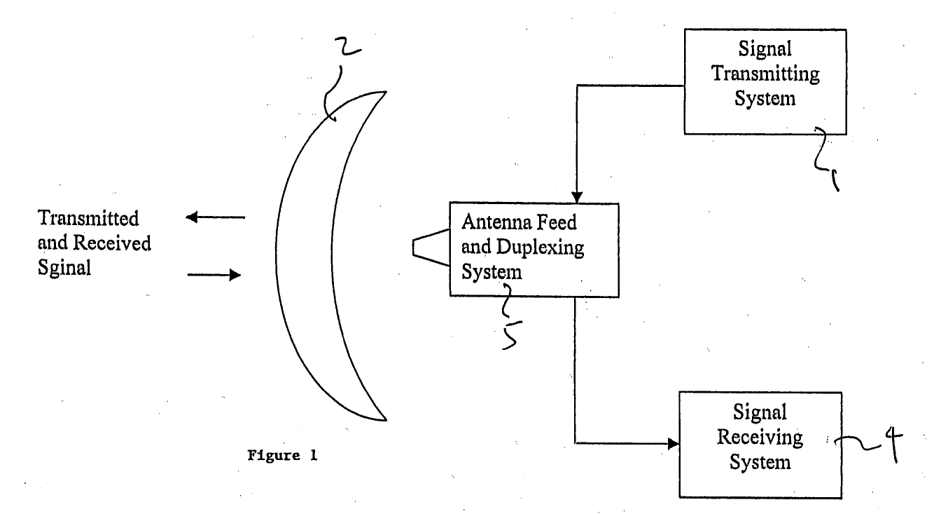

### DETAILED DESCRIPTION OF THE INVENTION

A radar installation includes a waveform generator 1, an antenna 2 for transmitting electromagnetic waves or energy to or at a target, an antenna 2 for receiving electromagnetic waves or energy reflected from the target, and a waveform detector 4 for detecting and analysing the waves or energy reflected from the target.

A radar installation using a single antenna 2 to both transmit and receive waves or signals requires a duplexer arrangement 5.

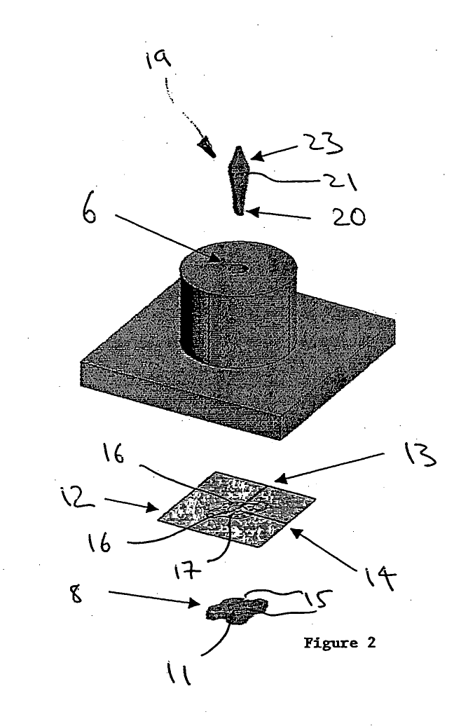

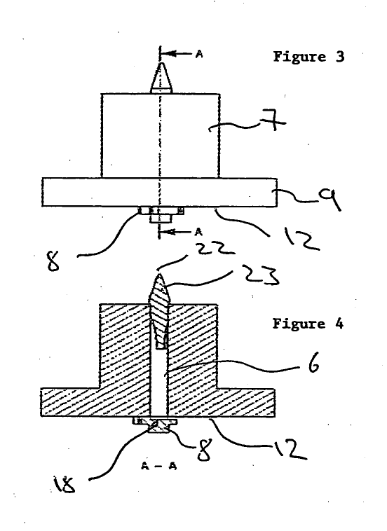

FIGS. 2 and 3 illustrate a duplexing arrangement suitable for radar transceiver applications. This would be most suitable for frequencies in the range of approximately 5 to 150 GHz. A possible application for such frequencies is a car radar transceiver.

The duplexer 5 comprises a waveguide 6 defined by a tubular waveguide element 7 and a backshort element 8 which may be screwed to a flat base 9 formed around the bottom of the tubular waveguide element. The backshort and tubular waveguide elements are made from an electrically conducting metal such as copper, brass or aluminium material.

The passage 10 through the tubular waveguide element and the circular hole or space 11 in the top of the backshort together define the waveguide 6.

A substrate 12 supporting orthogonal input 13 and output lines 14 is held between the backshort 8 and the base 9 of the tubular waveguide element 7. The backshort includes channels 15 which define apertures in the side of the waveguide through which the input and output lines pass. The input and output lines each terminate in narrow strip probe elements 16 having ends in contact with respective edges of a conductive patch 17.

The substrate 12 may be made from a suitable low loss microwave substrate such as PTFE softboard, ceramic or quartz material onto which the transmission lines and the conductive patch may be photo defined and etched in the case of board material and fired on ceramic material.

The backshort 8 is dimensioned such that the substrate and probe elements 16 supported thereon are approximately 1/4 of a wavelength from the end wall 18 of the waveguide. For a radar transceiver operating at 77 GHz, this distance is approximately 0.5 mm behind the back face of the substrate and is shorter than ¼ wavelength due to the dielectric effects of the substrate.

A combined antenna feed and polarising vane 19 is located at the upper end of the waveguide. The combined antenna feed and polarising vane is made from a cross-linked polystyrene dielectric material.

The polarising vane is defined by a wedge-shaped portion 20 of dielectric material which is approximately 8.0 mm long and arranged in the waveguide 6 so that the axis along the edge of the end of the wedge is at 45° to (i.e. bisects the angle between) the directions of the input and output lines. The wedge portion 20 of the polariser merges or tapers into a circular cross-section 21 before tapering to a tip 22. The length of the taper feed section is approximately 5.0 mm long but this may vary depending on the antenna to be fed. The upper conical taper element 23 defines the antenna feed. The antenna feed is a polyrod antenna feed. The length of the whole section is approximately 14 mm long and 3.0 mm in diameter

The device or arrangement described above with reference to FIGS. 2 to 4 uses the properties of a circularly polarised wave to achieve good isolation between the transmitted and received signals in a radar transceiver.

For circular polarisation when viewed from the direction of travel of the wave, a wave spinning in an anti-clockwise direction leaving the radar will, when it bounces off an object or target and returns to the radar, will appear to the vane as spinning in a clockwise direction. The duplexer arrangement uses the different directions of spin of transmitted and reflected circularly polarised waves to duplex or route the transmitted and reflected waves.

The device or arrangement described above with reference to FIGS. 2 to 4 will operate as follows.

The angle of the wedge-shaped vane 20 relative to the linear polarisation of the wave feeding into it, determines the direction of the rotation of the resulting circularly polarised wave. For a vertical wave hitting a vane tilted at 45 degrees to the left, the resulting wave would have an anticlockwise rotation. If the vane had a 45 degree tilt to the right, it would have a clockwise rotation. When for example a linear polarised wave from the transmit or input probe 13 passes through the vane 20, a circularly polarised wave emerges from the upper portion 23 (from the antenna feed) and travels to the target. The returned circularly polarised wave passes through the feed 23 to the wedge-shaped vane 20 where it will become linear horizontally polarised relative to the vertical plane that originally transmitted it. This would cause it to appear at the other probe 14, the output on the substrate, and isolated from the vertical input probe 13.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A radar duplexing arrangement for permitting a single antenna to transmit and receive electromagnetic radiation, comprising:
a circular waveguide;
a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide;
a polariser disposed within the waveguide for conversion of linear waves into circular waves and vice-versa; and
an antenna feed in communication with the polariser to transmit and receive circular waves.

2. An arrangement according to claim 1 wherein the polariser is a dielectric vane with a wedge-shaped portion whose edge axis is arranged at 45° to both said conductive lines.

3. An arrangement according to claim 2 wherein the antenna feed is a dielectric antenna feed integral with and formed of the same material as the dielectric vane.

4. An arrangement according to claim 1 further comprising a signal transmitting and/or generating system for transmitting and/or generating a signal having a frequency in the range 5 to 150 Ghz.

5. An arrangement according to claim 4 wherein the signal transmitting or generating system is for transmitting and/or generating a signal having a frequency in the range 50 to 100 Ghz.

6. An arrangement according to claim 5 wherein the signal transmitting or generating means is for transmitting and/or generating a signal having a frequency of substantially 77 GHz.

7. A radar transceiver including a radar duplexing arrangement according to claim 1.

8. A radar transceiver according to claim 7 for use in a land vehicle.

9. A car radar duplexing arrangement for permitting a single antenna to transmit and receive electromagnetic radiation, comprising:
a circular waveguide;
a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide;
a polariser disposed within the waveguide for conversion of linear waves into circular waves and vice-versa; and
an antenna feed in communication with the polariser to transmit and receive circular waves.

10. A radar duplexing arrangement for permitting a single antenna to transmit and receive electromagnetic radiation, comprising:
a circular waveguide;
a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide;
a polariser disposed within the waveguide for conversion of linear waves into circular waves and vice-versa; and
an antenna feed in communication with the polariser to transmit and receive circular waves
wherein the polariser is a dielectric vane with a wedge-shaped portion whose edge axis is arranged at 45° to both said conductive lines and the antenna feed is a dielectric antenna feed integral with and formed of the same material as the dielectric vane.

11. A radar duplexing arrangement for permitting a single antenna to transmit and receive electromagnetic radiation, comprising:
a circular waveguide;
a waveguide coupling arrangement for coupling energy between two conductive lines and said circular waveguide, wherein said two conductive lines comprise mutually orthogonal conductors disposed normally with respect to the waveguide axis, and each extending through a respective aperture in the wall of said waveguide;
a polariser disposed within the waveguide for conversion of linear waves into circular waves and vice-versa; and
an antenna feed in communication with the polariser to transmit and receive circular waves
wherein the polariser is a dielectric vane with a wedge-shaped portion whose edge axis is arranged at 45° to both said conductive lines, the antenna feed is a dielectric antenna feed integral with and formed of the same material as the dielectric vane and the signal transmitting or generating means is for transmitting and/or generating a signal having a frequency of substantially 77 GHz.
